(19) United States
(12) Patent Application Publication
(10) Pub. No.: US 2011/0210920 A1
(43) Pub. Date: Sep. 1, 2011

(54) Multiple-factor input devices and methods

(76) Inventor: Yanlei Tan, Fremont, CA (US)

(21) Appl. No.: 12/806,579

(22) Filed: Aug. 16, 2010

Related U.S. Application Data
(60) Provisional application No. 61/274,430, filed on Aug. 16, 2009.

(51) Int. Cl. G09G 5/00; G06F 3/02

(52) U.S. Cl. 345/168; 345/156

(57) ABSTRACT

An input device includes a first identifying factor input zone with a zone characteristic to provide a first identifying factor wherein the first identifying factor input zone further receives and detects a user action for inputting a second identifying factor to identify a combined input according to the first and second identifying factor. In a specific embodiment, the first identifying factor input zone further comprises a fingerprint detector to receive and detect user's fingerprints for inputting the second identifying factor to identify a combined input according to the first and second identifying factors. In another specific embodiment, the first identifying factor input zone further comprises a bar code number detector to receive and detect bar code numbers on user's fingers for inputting the second identifying factor to identify a combined input according to the first and second identifying factors.

This application is a Non-provisional application claiming a Priority date of Aug. 16, 2009 based on a previously filed Provisional Application 61/274,430. The disclosures made in Patent Application 61/274,430 filed by the same Applicant of this Non-Provisional application are hereby incorporated by reference in this patent application.

### BACKGROUND OF THE INVENTION

1. Field of the Invention

This invention relates generally to input devices and methods for entering data and control signals to electronic data handling and information processing devices or systems. More particularly, this invention is related to input devices and methods for applying at least two factors for entering data and control signals into electronic data handling and information process devices or systems.

2. Description of the Prior Art

An input device or system is used to provide data and control signals to the information processing systems or data handling devices such as a computer, the personal digital assistant (PDA) devices, cellular phones, global position systems (GPS), or electronic musical keyboard instruments.

FIG. 1 shows a computer QWERTY-based keyboard as one of the conventional input devices that is commonly applied to enter alphabetic characters, symbols, and numbers or control signals. A user's keystroke that presses down a key on the keyboard generates an input entry to the computer corresponding to an alphabet, a symbol, a number or a control signal represented by the key. A computer receives an input entry that is correspondent to each key irrespective of a particular finger used to press down the key. The key that is pressed down is a “single factor” that dedicates the input entry transferred to the computer. Typical input devices, including the keyboard as discussed above and the conventional music keyboard, game terminal, and other electrical-mechanical type of control consoles are commonly implemented as “single factor” input devices.

As more and more portable electronic devices such as the smart phones, the PDA and even the mini-laptop computers are manufactured with ever miniaturized size to achieve greater portability, the actions for input entry into these devices have become more cumbersome due to the shrunken size of these devices. As the electronic devices are produced with smaller size, so is the size of the keypads of the input devices on these miniaturized devices. According to the traditional computer keyboard shown in FIG. 1, there are 5 main rows of keys that related the 26 letters and 0˜9 numbers, as show in the figure blow. In the 1st key row there are 10 number keys and 4 other keys; in the 2nd key row there are 10 letter keys and 4 other keys; in the 3rd key row there are 9 letter key and 4 other keys; in the 4th key row there are 7 letter keys and 5 other keys. The 5th row includes a space bar and control keys.

With multiple keypads implemented in the conventional keyboard shown in FIG. 1, as a consequence of implementing a smaller keypad in the miniaturized portable devices, a user has to be more careful in order to press a correct key in the processes of operating these devices. More focused attention is required in operating these devices while input entry actions are often slowed down due to a higher precision requirement when smaller keypads are used in the input device.

In the meantime, as the ever increasing number of portable electronic devices are produced and operated by increased number of people, there are urgent needs to resolve the difficulties caused by the miniaturized input keypads. The efforts of generating input entries through mechanical contact onto these small keypads not only require greater precision in placing the fingers on the keypads, long time operation of these devices further cases sore eyesight and anxiety due to greater concentration is required to carry out the input processes.

Some languages have more characters then the 26 characters of English, such as Chinese and Japanese which have thousands of possible characters. Many methods have been used to fit all these possible characters into a QWERT conventional keyboard. Since their input methods have not one-to-one mapping between keys and characters, the input methods are much more complex then English input. Normally by entering the desired character's pronunciation the range of possibilities is narrowed and showed out as a character list, and then by typing the number before the desired character in the list, the desired character is entered. Typing in these languages, especially Chinese, is slower and more difficult than typing English for a regular user. For Chinese, some typists use faster input methods by typing character structure components, radicals, or stroke count, but the structural methods are the most difficult to learn. In those structural methods, each key in the keyboard will be mapped to more then one of those components, radicals, or stroke counts. The less a key mapped to those components, the faster and easier the input can be achieved. To have those benefits, more keys from the same or less size of a QWERT conventional keyboard are needed.

Therefore a need still exists to implement improved input processes with new device configurations such that the above discussed difficulties and limitations may be resolved.

### SUMMARY OF THE PRESENT INVENTION

It is therefore an aspect of the present invention to provide new and improved device configurations to implement more simplified input processes such that the above discussed difficulties and limitations can be overcome.

Specifically, it is an aspect of the present invention to provide a new and improved device configuration to process a multiple-factor, such as a two-factor input operation, by implementing an input device that can produce input signals by recognizing at least two identifiers generated by a user's input action. With application of at least two identifiers to recognize the user input actions, the input processes can be simplified and the difficulties caused by the small size of the portable electronic device can be overcome.

Briefly, in a preferred embodiment, the present invention discloses an input device comprises a first identifying factor input zone to receive a user action for inputting a second identifying factor to identify a combined input according to the first and second identifying factor. In an exemplary embodiment, the second identifying factor comprises fingerprints of a user of the input device. In another exemplary embodiment, the second identifying factor comprises bar codes disposed on fingers of a user of the input device. In another exemplary embodiment, the first identifying input zone comprises a designate input area on the input device.

In summary this invention discloses a method for using an input device to enter an input to an electronic data handling or an information processing system. The method includes a step of providing a first identifying factor input zones on the input device to receive a second identifying factor through a user's action on the input zones. The method further comprises a step of combining the first identifying factor with the second identifying factor for generating an input entry according to predefined rules for mapping and combining the first and second identifying factors. In an exemplary embodiment, the step of receiving a user's action for inputting the second identifying factor further comprises a step of receiving and inputting user's fingerprints as the second identifying factor when typing onto the first identifying factor input zones. In another embodiment, the step of receiving a user's action for inputting the second identifying factor further comprises a step of receiving and inputting bar code numbers on user's fingers as the second identifying factor when typing onto the first identifying factor input zones.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIG. 1 shows the conventional configuration and layout of an input device for different electronic devices.

FIG. 2 shows a new and improved configuration and layout of an input device implemented with the two-factor input entry methods of this invention.

FIG. 3 shows a two-fact input system with guide rails as another embodiment of this invention

### DETAILED DESCRIPTION OF THE PREFERRED EMBODIMENT

The present invention provides input devices and method of implementing a two-factor input process for entering input entries to an information processing system. The two-factor input process generates two input identifiers. An information processing system which receives these two identifiers infers and determines what is inputted. The two factors are inputted from two different objects. Each object has a unique identifier. When the two objects physically touch or move to close each other, an input activity is trigged and both of the two identifiers are provided to the information processing system. The information processing system uses both of the two identifiers to infer and determine what is inputted. Namely the two factors are the two identifiers which are used to infer and determine a unique data item, a command signal, or a specific symbol entered by the user through an input action executed on the input device.

Typically one of the objects is a signal source; another one is a signal receiver which can read the signal from the source object. When a signal source object touches or moves close to the receiver, the receiver will be trigged to receive the signal from source object and decode the signal to the identifier of source object; and then the receiver will provide the identifiers of both the source and the receiver into the information processing system.

Normally a finger is used as a signal source object or a carrier of an input factor which carries a signal source. A signal source can be anything that has a sign or a signal which can be used to identify the object (finger), i.e. the fingerprint, the finger color and shape, or a barcode stick, a color image stick, a RFID card, a sound generator, a resister, or a capacitor which is attached on a finger with a finger cap, clip or glove. A signal receiver is a device that is able to receive the related signal from the source, i.e. a fingerprint reader, a camera, a barcode reader, a color light sensor, an infrared camera, a RFID reader, a sound receiver, or an ohm meter. Those signal sources or receivers are not limited in the examples listed above.

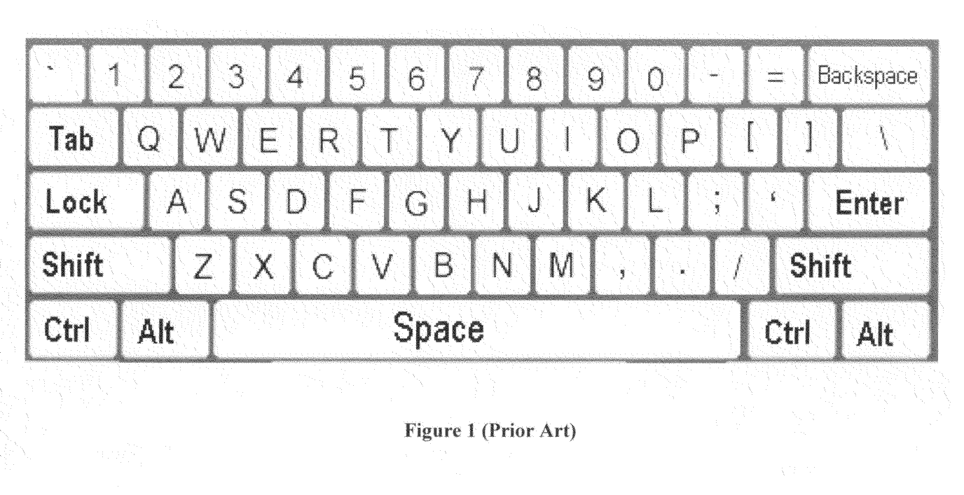

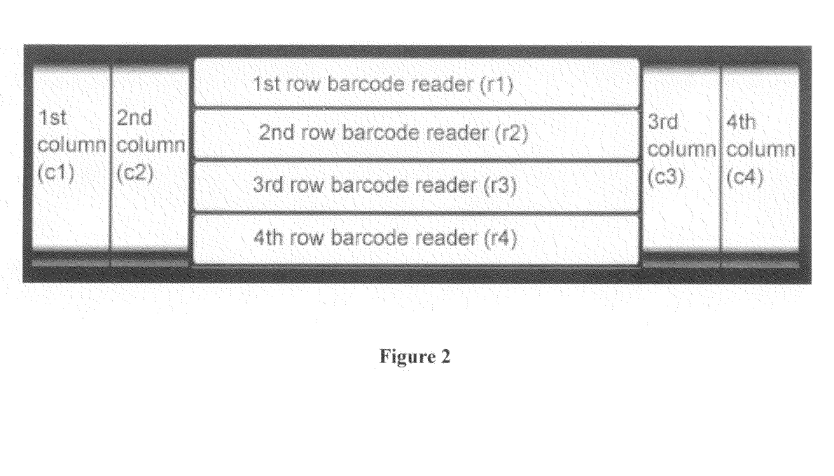

Refer to FIG. 2 for a two-fact input device as an embodiment to apply the two-factor input method of this invention. Instead of the conventional keyboard as that shown in FIG. 1, the two-factor input keyboard includes eight input zones. These input zones are implemented as four horizontal rows designated as r1, r2, r3, and r4 and four vertical columns c1, c2, c3, and c4 with c1 and c2 disposed on the left-hand side of the four horizontal rows and c3 and c4 disposed on the right-hand side of the four horizontal rows. This two-factor input device is configured to take advantage of the conventional touch-typing technique that is commonly applied in a conventional keyboard shown in FIG. 1. Each finger of a user typing on a conventional keyboard may be required to type multiple keys. For example, right index finger is used for “7ujmyhn” and both thumbs are used for operating the “space” bar.

In order to apply a two-factor input method on the keyboard shown in FIG. 2, each finger of the keyboard user is designated with a specific identifier to enter a second-factor when a particular finger is moved to touch a particular input zone that identifies the first factor in operating the two-factor input device. In a specific embodiment, each finger of the keyboard user is attached with a bar code number as the finger's identifier. The bar code numbers assigned to the fingers on the right hand are: thumb—f0, index—f1, middle—f2, ring—f3, and pinky—f4. The bar code numbers assigned to the fingers on the right hand are: thumb—f5, index—f6, middle—f7, ring—f8, pinky—f9. The eight input zones are arranged as four horizontal rows, rows r1, r2, r3, and r4, and four vertical columns, e.g., column c1, c2, c3 and c4 of the keyboard. These eight input zones are implemented with eight barcode readers to detect the bar code numbers associated with different figures. Each of the bar code readers are also assigned with an identifier, i.e. the 1^{st}, e.g., the top horizontal, barcode reader is assigned as “r1”, the 2^{nd} as “r2”, the 3^{rd} as “r3”, the 4^{th} as “r4. The four vertical columns of the input keyboards are also implemented as barcode readers and assigned with identifiers as c1, c2, c3, and c4.

When a finger moves close to a barcode reader, the reader is triggered to read the finger barcode number. There are two factors including the identifiers of the finger and also bar code reader numbers are sent to the computer. The electronic device, e.g., the computer connected to the keyboard, receives these two identifiers and applies these two identifiers to determine an input data or control signal based on a set of predefined rules as that listed in the Table 1 below. The predefined rules defined in Table 1 provide a lookup-table to map a character, a symbol, and a number or a control signal to the two factors. Basically, the predefined rules are setup according to the conventional touch-typing technique such that a user can basically operate just as if the input entry is carried out by applying a conventional typing process. A user operates this new and improved keyboard can carry out the typing without great deal of adjustments from the traditional typing processes except that the fingers are not required to touch and press precisely on a tiny keypad. The input entry when operated on this new and improved keyboard can be carried out by moving the fingers to touch one of four input rows and four columns and these input rows and input columns has much enlarged input zones.

TABLE 1

| | c1 | c2 | r1 | r2 | r3 | r4 | c3 | c4 |
|---|---|---|---|---|---|---|---|---|
| f0 (right thumb) | | | | Y | H | N | Backspace | |
| f1 (right index) | | | 7 | U | J | M | − | = |
| f2 (right middle) | | | 8 | I | K | , | [ | ] |
| f3 (right ring) | | | 9 | O | L | . | \ | Enter |
| f4 (right pinky) | | | 0 | P | ; | / | ′ | Shift |
| f5 (left thumb) | | Lock | | | G | V | | |
| f6 (left index) | | | 6 | T | F | C | | |
| f7 (left middle) | ` | Alt | 5 | R | D | X | | |
| f8 (left ring) | Tab | Q | 4 | E | S | Z | | |
| f9 (left pinky) | 1 | 2 | 3 | W | A | B | | |

From the list shown in Table 1, the right index finger will be used for “7ujm-=”; the right middle finger will be used for “8ik,[ h]”; the right ring finger will be used for “9ol.\” and “enter”; the right pinky finger will be use for “0p;/” and “shift”; the right thumb will be used for “yhn” and bksp”; the left index will be used for “6tfc”; the left middle finger will be used for “alt” and“‘5rdx”; the left ring finger will be used for “tab” and “q4esz”; the left pinky will be used for “123wab”; the left thumb will be used for “lock” and “gv”. Most of those definitions follow the touch typing technique. Some changes are made to make sure all the keys can be entered, i.e. in the touch typing technique thumbs are used only for “space”, but in this list thumbs needs to be used for other keys.

When right index finger with identifier “f1” touches (or moves close to) the 3rd row reader with the identifier “r3”, the computer will receive the two factors “f1” and “r3”. According the predefined rules, the computer will infer the letter “j” is inputted.

The above description for a keyboard shown in FIG. 2 just basically explains how the two-factor input device and method works. But the applications of the two-factor devices and methods are not limited to the input devices of computers only. An input device based on the methods of applying identifiers as a two-factor or multiple-factor input device can be implemented in many different electronic data handling devices or information processing systems. These electronic data handling devices or information processing systems may include electronic musical keyboard instruments, laptop computers, and mobile devices and so on. And it is not limited to be used as traditional keyboard style input device, it can be used in many different styles, such as software on-screen keyboard or joystick styles input device, and it can even be used to created some new style input devices that have not been existing so far. Using two-factor or multiple-factor input device and method as opposed to one factor input device and method generally makes input equipment simpler to make, easier to use, faster to enter, smaller in size, and more capability and possibility to input data or signal.

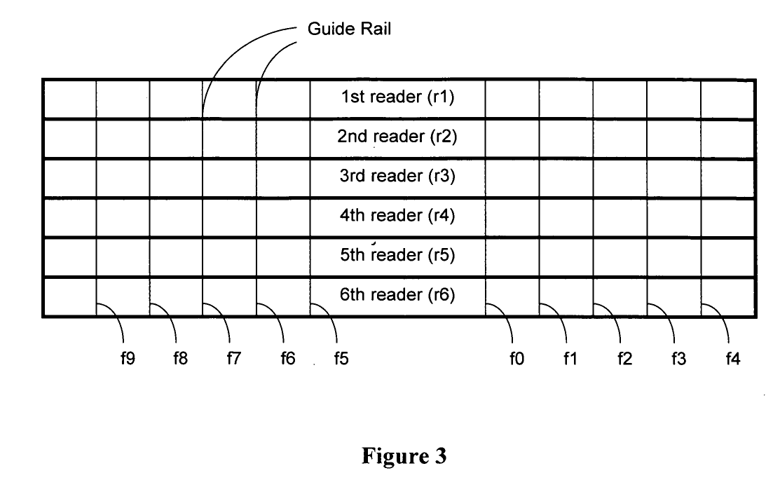

Some users could feel inconvenient if they took identifier carriers such as finger caps, or gloves which are the medias that hold the identifiers. In order to make it more convenient for those users, guide rails could be mounted on the input device of the present invention. The guide rails are to hold identifiers so that a finger can easily control its relevant identifier to do back and forth movement and to push the identifier to touch or close to the input zone for entering an input entry. FIG. 3 shows 10 guide rails with identifiers and 6 row readers. Each identifier represents a relevant finger, (f0—right thumb; f1—right index; f2—right middle; f3—right ring; f4—right pinky; f5—left thumb; f6—left index; f7—left middle; 8—left ring; f9—left pinky). The combinations of the identifiers and readers can generate different input entries. The guide rails could be demounted if a user wanted to take identifier carriers such as finger caps, or gloves.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. An input device comprising:
a first identifying factor input zone with a zone characteristic to provide a first identifying factor wherein said first identifying factor input zone further receives a second identifying factor through a user's action on the input zone to identify a combined input according to said first and second identifying factor.

2. The input device of claim 1 wherein:
the first identifying factor input zone further comprises a fingerprint detector to receive and detect user's fingerprints for inputting a second identifying factor to identify a combined input according to the first and second identifying factors.

3. The input device of claim 1 wherein:
the first identifying factor input zone further comprises a bar code number detector to receive and detect bar code numbers on user's fingers for inputting a second identifying factor to identify a combined input according to the first and second identifying factors.

4. The input device of claim 1 wherein:
the first identifying factor input zone further has a zone location as said zone characteristic to provide said first identifying factor.

5. A method for using an input device to enter an input to an electronic data handling device or an information processing system comprising:
providing first identifying factor input zones on the input device to receive a user's action for inputting a second identifying factor through the user's action; and
combining the first identifying factor with the second identifying factor for generating a input entry according to a predetermined rules for mapping and combining the first and second identifying factors.

6. The method of claim 5 wherein:
the step of receiving a user's action for inputting the second identifying factor further comprises a step of receiving and inputting user's fingerprints as the second identifying factor when typing onto the first identifying factor input zones.

7. The method of claim 5 wherein:
the step of receiving a user's action for inputting the second identifying factor further comprises a step of receiving and inputting bar code numbers on user's fingerprints as the second identifying factor when typing onto the first identifying factor input zones.
